(19) United States
(12) Patent Application Publication
(10) Pub. No.: US 2016/0064869 A1
(43) Pub. Date: Mar. 3, 2016

(54) ELECTRICAL CONNECTOR WITH IMPROVED GROUNDING MECHANISM

(71) Applicant: ALLTOP ELECTRONICS (SUZHOU) LTD., Taicang City (CN)

(72) Inventors: Wang-I YU, Jhonghe City (TW); Li-Li LIANG, Jhonghe City (TW); Yong-Gang ZHANG, Jhonghe City (TW); Mao-Jung HUANG, Jhonghe City (TW); Kun LIU, Jhonghe City (TW)

(73) Assignee: ALLTOP ELECTRONICS (SUZHOU) LTD., Taicang City (CN)

(21) Appl. No.: 14/552,689

(22) Filed: Nov. 25, 2014

(30) Foreign Application Priority Data
Sep. 3, 2014 (CN) 201410445126.X

(51) Int. Cl. H01R 13/6585; H01R 24/60; H01R 13/6597

(52) U.S. Cl. CPC H01R 13/6585; H01R 13/6597; H01R 24/60; H01R 2107/00

(57) ABSTRACT

An electrical connector includes an insulative housing, a number of contacts retained in the insulative housing, a metallic grounding plate and a metallic inner shell. The insulative housing includes a base and a tongue portion protruding forwardly from the base. The contacts are divided into a plurality of upper contacts and a plurality of lower contacts. The metallic grounding plate is positioned between the upper contacts and the lower contacts. The metallic inner shell includes a top shell and a bottom shell separately made from each other. The metallic grounding plate is positioned between the top shell and the bottom shell. The metallic inner shell and the metallic grounding plate are in contact with each other in order to realize a relative larger grounding area.

### CROSS REFERENCE TO RELATED APPLICATIONS

The present application claims the priority of Chinese patent application Ser. No. 201410445126.X filed Sep. 3, 2014 in the SIPO (Sate Intellectual Property Office of the P.R.C.), which is incorporated by reference herein in its entirety.

### BACKGROUND

1. Technical Field

The present disclosure relates to an electrical connector, and more particularly to an electrical connector having an improved grounding mechanism for realizing robust grounding effect.

2. Description of Related Art

A conventional I/O connector for being mounted to a circuit board usually includes an insulative housing, a plurality of contacts retained in the insulative housing and an outer shell enclosing the insulative housing. The insulative housing usually includes a base and a tongue portion extending from the base. Since the tongue portion is usually thinner than the base, the strength of the tongue portion maybe not strong enough. The contacts may include a group of first contacts located at a top side of the tongue portion and a group of second contacts located at a bottom side of the tongue portion. Since the first contacts and the second contacts are adjacent with each other, signal interference generated therebetween may render poor signal transmission quality.

Hence, it is desirable to provide an electrical connector with robust grounding effect to improve signal transmission quality.

### SUMMARY

The present disclosure provides an electrical connector including an insulative housing, a plurality of contacts retained in the insulative housing, a metallic grounding plate and a metallic inner shell attached to the insulative housing. The insulative housing includes a base and a tongue portion protruding forwardly from the base. The tongue portion includes a top surface and a bottom surface opposite to the top surface. The contacts are divided into a plurality of upper contacts and a plurality of lower contacts. Each contact includes a contacting portion. The contacting portions of the upper contacts and the lower contacts are exposed on the top surface and the bottom surface of the tongue portion, respectively. The metallic grounding plate is positioned between the contacting portions of the upper contacts and the contacting portions of the lower contacts. The metallic inner shell includes a top shell and a bottom shell separately made from each other. The metallic grounding plate is positioned between the top shell and the bottom shell. The metallic inner shell and the metallic grounding plate are in contact with each other in order to realize a relative larger grounding area.

The foregoing has outlined rather broadly the features and technical advantages of the present disclosure in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of an electrical connector in accordance with a first embodiment of the present disclosure with an outer shell removed therefrom;

FIG. 2 is an exploded view of the electrical connector shown in FIG. 1;

FIG. 3 is a perspective view of an insulative housing of the electrical connector;

FIG. 4 is an exploded view of the insulative housing shown in FIG. 3;

FIG. 5 is a perspective view of upper contacts and lower contacts;

FIG. 6 is a perspective view of an inner shell shown in FIG. 2;

FIG. 7 is a perspective view of a grounding plate shown in FIG. 2;

FIG. 8 is a perspective view of the inner shell and the grounding plate mating with each other;

FIG. 9 is a perspective view of an electrical connector in accordance with another embodiment of the present disclosure; and

FIG. 10 is a perspective view of the electrical connector with an insulative housing removed therefrom.

### DETAILED DESCRIPTION OF ILLUSTRATED EMBODIMENTS

Reference will now be made to the drawing figures to describe the embodiments of the present disclosure in detail. In the following description, the same drawing reference numerals are used for the same elements in different drawings.

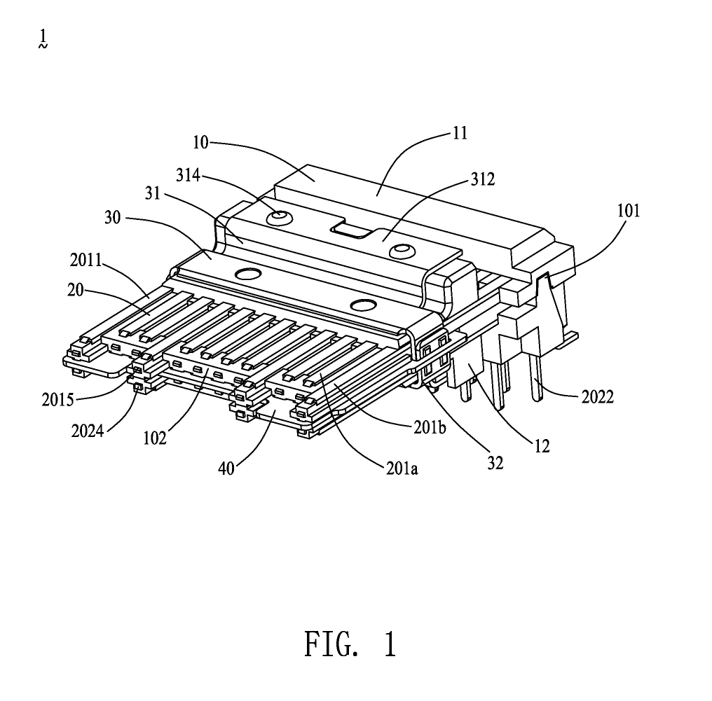

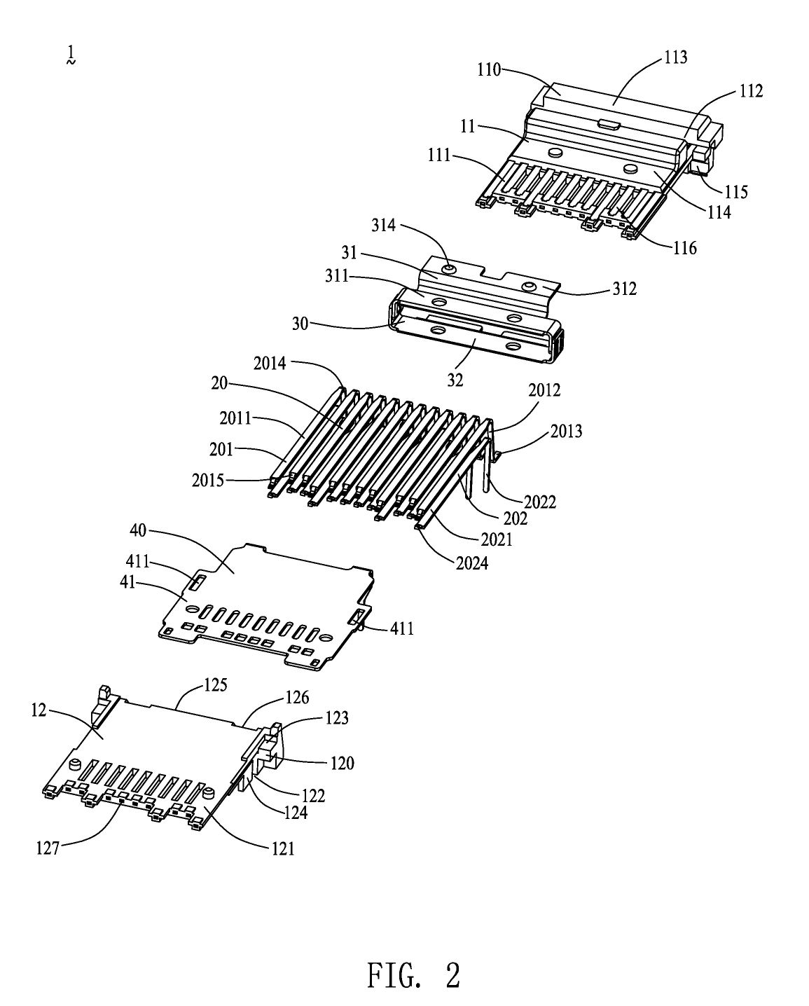

Referring to FIGS. 1 and 2, the present disclosure discloses an electrical connector 1 capably of being mounted to a circuit board (not shown) for receiving a plug connector (not shown). The electrical connector 1 includes an insulative housing 10, a plurality of contacts 20 retained in the insulative housing 10, a metallic outer shell (not shown) enclosing the insulative housing 10, a metallic inner shell 30 located between the insulative housing 10 and the outer shell, and a grounding mechanism fixed in the insulative housing 10.

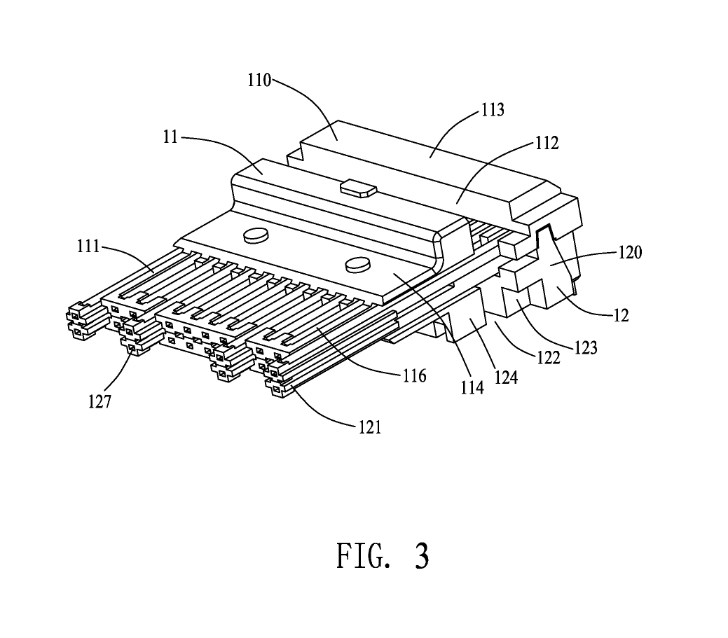

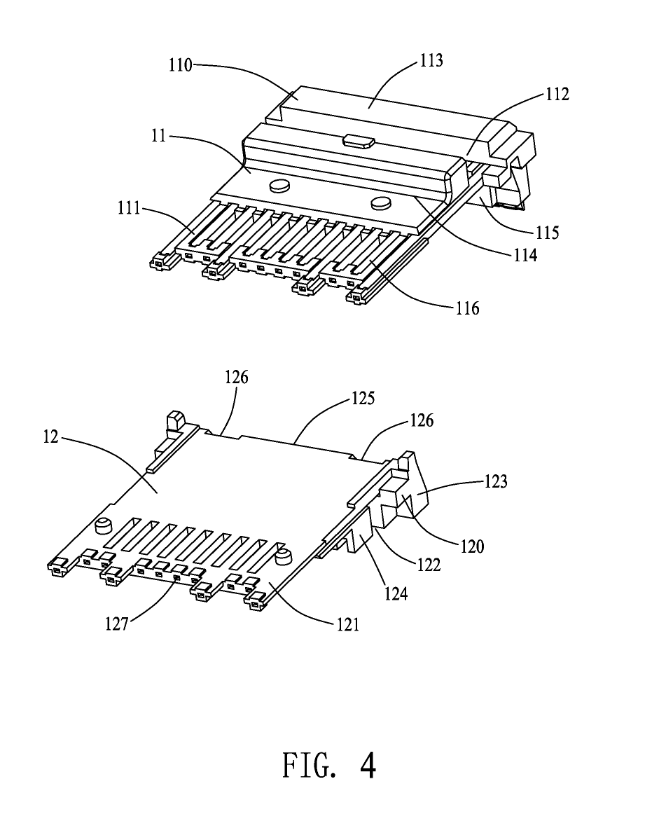

Referring to FIGS. 1 to 4, the insulative housing 10 includes a base 101 and a tongue portion 102 protruding forwardly from the base 101. The contacts 20 include a plurality of upper contacts 201 located at a top side of the tongue portion 102 and a plurality of lower contacts 202 located at a bottom side of the tongue portion 102. The insulative housing 10 includes an upper housing 11 and a lower housing 12 assembled together with the upper housing 11. The upper housing 11 includes an upper base portion 110 and an upper tongue portion 111 extending forwardly from the upper base portion 110. The thickness of the upper base portion 110 is larger than the upper tongue portion 111. The upper base portion 110 defines an upper recess 112 opposite to the lower housing 12. The upper base portion 110 is divided into a rear portion 113 and a front portion 114 by the upper recess 112.

The rear portion 113 includes a mating surface 115 for contacting the lower housing 12 and a pair of blocks (not shown) formed on the mating surface 115. The upper housing 11 includes a plurality of upper slots 116 for receiving the upper contacts 201. The upper slots 116 extend through the upper base portion 110 and the upper tongue portion 111 along a front to back direction. The upper slots 116 are exposed to the air.

The lower housing 12 includes a lower base portion 120 and a lower tongue portion 121 extending forwardly from the lower base portion 120. The thickness of the lower base portion 120 is larger than the lower tongue portion 121. The lower base portion 120 defines a lower recess 122 opposite to the upper housing 11. The lower base portion 120 is divided into a rear portion 123 and a front portion 124 by the lower recess 122.

The rear portion 123 includes a mating surface 125 for contacting the mating surface 115 and a pair of depressions 126 for receiving the blocks. The lower housing 12 includes a plurality of lower slots 127 for receiving the lower contacts 202. The lower slots 127 extend through the lower base portion 120 and the lower tongue portion 121 along the front to back direction. The lower slots 127 are exposed to the air.

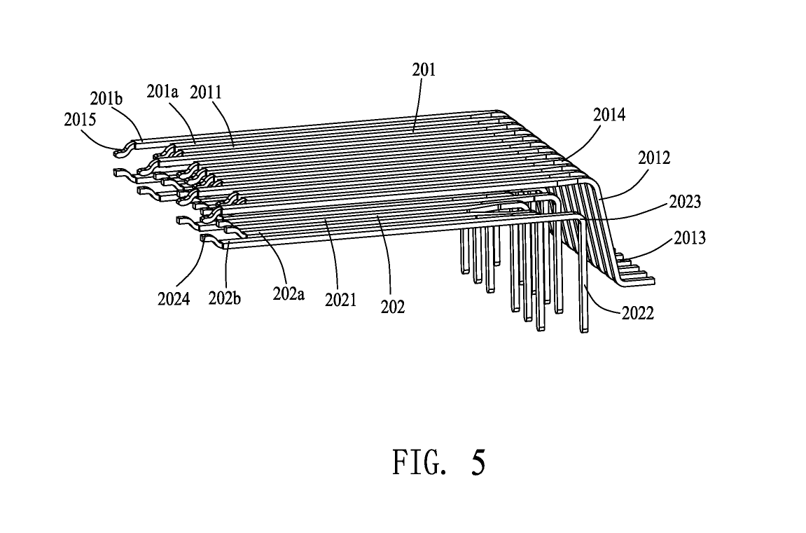

Referring to FIGS. 1 to 5, the upper contacts 201 are arranged in a side-by-side manner. Each upper contact 201 includes an upper contacting portion 2011 extending to the upper tongue portion 111, a slant portion 2012 extending slantwise from the upper contacting portion 2011, an upper soldering portion 2013 extending horizontally from the slant portion 2012, and an upper connecting portion 2014 connected between the upper contacting portion 2011 and the slant portion 2012. Besides, each upper contacting portion 2011 includes an upper protrusion 2015 bent downwardly from a front end thereof. The upper protrusions 2015 are embedded in the upper housing 11 for fixation when the upper housing 11 is inject-molded with the upper contacts 201. The upper soldering portions 2013 are so-called SMT types and are arranged in a single row for being easily soldered onto the circuit board. The upper contacts 201 include a plurality of first contacts 201a for transmitting signal or power (also known as signal contacts or power contacts, respectively), and a plurality of second contacts 201b for grounding (also known as ground contacts). In a single row, the first contacts 201a are located between the second contacts 201b. Two grounding contacts G of the second contact 201b are located at outmost lateral sides. In a single row, according to the illustrated embodiment of the present disclosure, the first contacts 201a include three pairs of differential signal contacts and some power contacts.

The lower contacts 202 are arranged in a side-by-side manner. Each lower contact 202 includes a lower contacting portion 2021 extending to the lower tongue portion 121, a lower soldering portion 2022 extending downwardly from the lower contacting portion 2021, and a lower connecting portion 2023 connected between the lower contacting portion 2021 and the lower soldering portion 2022. Besides, each lower contacting portion 2021 includes a lower protrusion 2024 bent upwardly from a front end thereof. The lower protrusions 2024 are embedded in the lower housing 12 for fixation when the lower housing 12 is inject-molded with the lower contacts 202. The lower soldering portions 2022 are so-called Through Hole types and are arranged in two rows for being soldered through the circuit board. Of course, the arrangement of the upper soldering portions 2013 and the lower soldering portions 2022 can be designed in other types according to different requirements. For example, the lower soldering portions 2022 can also be arranged in a single row and/or the lower soldering portions 2022 can also be designed in SMT types. The lower contacts 202 include a plurality of third contacts 202a for transmitting signal or power (also known as signal contacts or power contacts, respectively), and a plurality of fourth contacts 202b for grounding (also known as ground contacts). In a single row, the third contacts 202a are located between the fourth contacts 202b. Two grounding contacts G of the fourth contact 202b are located at outmost lateral sides. In a single row, according to the illustrated embodiment of the present disclosure, the third contacts 202a include three pairs of differential signal contacts and some power contacts. According to the illustrated embodiment of the present disclosure, the upper contacts 201 and the lower contacts 202 are of the same type while in a reversed arrangement in order that the plug connector can be inserted into the electrical connector 1 either in a normal insertion or in a reverse insertion.

The outer shell defines a receiving opening to accommodate the tongue portion 102. The tongue portion 102 is located at a center of the outer shell along a vertical direction in order to realize that the plug connector can be inserted into the electrical connector 1 either in the normal insertion or in the reverse insertion. It is understandable that, in order to realize the plug connector can be inserted into the electrical connector 1 either in the normal insertion or in the reverse insertion, the distance between a top side of the tongue portion 102 and a top wall of the outer shell is the same as the distance between a bottom side of the tongue portion 102 and a bottom wall of the outer shell.

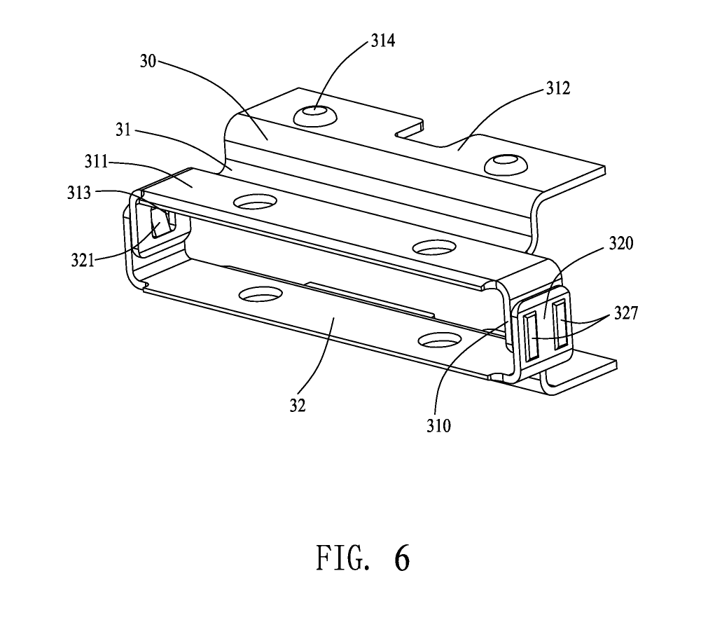

Referring to FIG. 6, the inner shell 30 includes a top shell 31 and a bottom shell 32. The top shell 31 and the bottom shell 32 are separately made and assembled together. According to the illustrated embodiment of the present disclosure, the top shell 31 and the bottom shell 32 are separately molded for reducing cost and easy manufacture. The top shell 31 is attached to a top side of the upper housing 11 and the bottom shell 32 is attached to a bottom side of the lower housing 12. One of the top shell 31 and the bottom shell 32 includes a hook 321, and a remaining one of the top shell 31 and the bottom shell 32 includes a hole 313 to receive the hook 321 so that the top shell 31 and the bottom shell 32 can be locked together. According to the illustrated embodiment of the present disclosure, the top shell 31 includes a mounting section 311, a rear section 312 extending backwardly from the mounting section 311 and a pair of top sidewalls 310 extending downwardly from the mounting section 311. The rear section 312 is U-shaped and higher than the mounting section 311 so as to form a stepped manner. According to the illustrated embodiment of the present disclosure, the hole 313 is formed on the top sidewall 310.

According to the illustrated embodiment of the present disclosure, the bottom shell 32 is positioned opposite to the top shell 31. The bottom shell 32 and the top shell 31 have similar configurations. The major difference is that the bottom shell 32 includes a pair of bottom sidewalls 320 extending upwardly. According to the illustrated embodiment of the present disclosure, the hook 321 is formed on the bottom sidewall 320. Each bottom sidewall 320 is stamped outwardly to form a pair of rectangular ribs 327. The bottom side walls 320 are located outside of the top sidewalls 310. After completing assembly of the top shell 31 and the bottom shell 32, the top sidewalls 310 and the bottom sidewalls 320 are jointed with each other so as to form a rectangular frame. The insulative housing 10 extends through the frame.

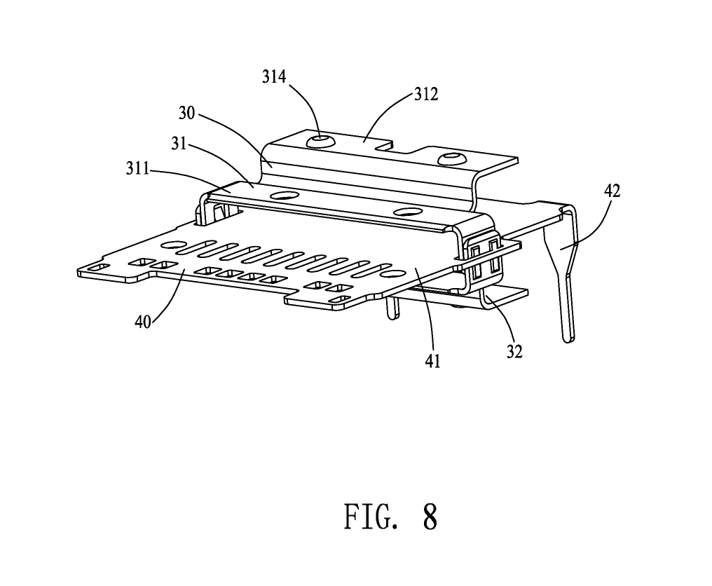

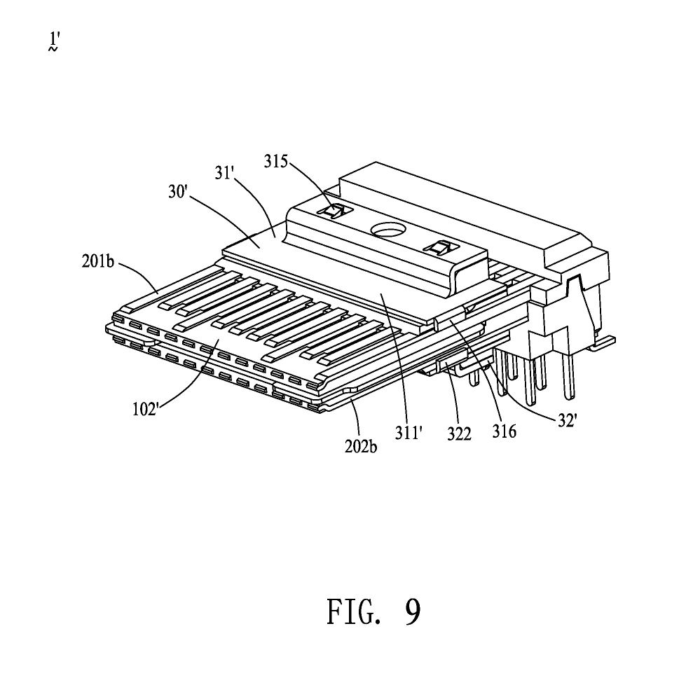

Referring to FIGS. 8 to 10, the outer shell and the inner shell 30 are in mechanical contact with each other via a connecting member for enlarge grounding area and decreasing signal interference. Referring to FIG. 6, according to the first illustrate embodiment of the present disclosure, the connecting member includes a protrusion 314 formed on the rear section 312. Referring to FIG. 9, according to the second illustrate embodiment of the present disclosure, the connecting member includes an elastic tab 315 formed on the rear section 312. Besides, the outer shell is capable of defining a connecting hole facing the inner shell 30 for receiving the connecting member in order to establish connection between the inner shell 30 and the outer shell. Besides, the connecting hole can also be a soldering hole which means that, when the outer shell is assembled to the insulative housing 10 in position, the inner shell 30 and the outer shell can be connected with each other via spot welding through the soldering hole.

Referring to FIGS. 1 and 9, the inner shell 30 is mounted to the the insulative housing 10. For one hand, the inner shell 30 can help to improve the strength of the insulative housing 10. For the other hand, the inner shell 30 can also improve some shielding function.

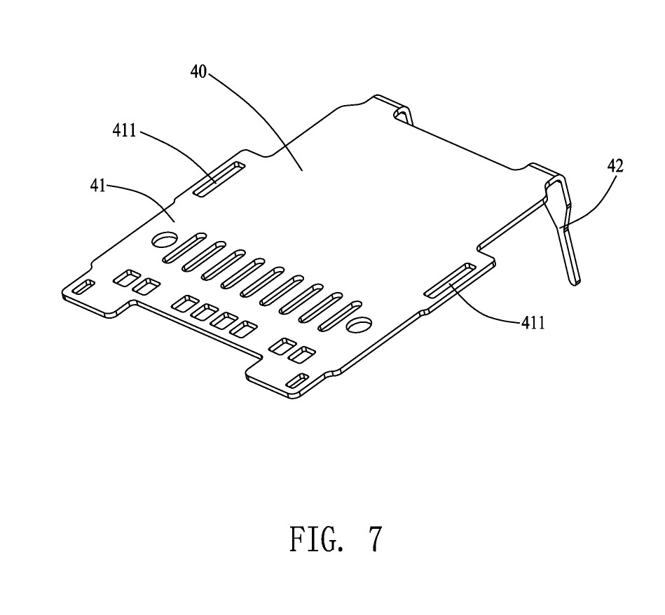

Referring to FIGS. 6 to 8, the grounding mechanism includes a grounding plate 40 is stamped from a metal sheet and located between the upper contacts 201 and the lower contacts 202. The grounding plate 40 includes a body 41 and a pair of soldering legs 42 extending downwardly from the body 41 for being soldered to the circuit board. The grounding plate 40 can not only reinforce the strength of the insulative housing 10 but also reduce the signal interference between the upper contacts 201 and the lower contacts 202. The body 41 includes two slots 411 through which the top sidewalls 310 and the bottom sidewalls 320 extend. The hook 321 and the hole 313 are mating with each other in the slots 411. Besides, with the top sidewalls 310 and the bottom sidewalls 320 extending through the grounding plate 40, the mechanical connection of the inner shell 30 and the grounding plate 40 is established. As a result, the inner shell 30, the grounding plate 40 and the outer shell are in series contact with each other in order to realize a relative larger grounding area. Therefore, the signal interference can be greatly decreased.

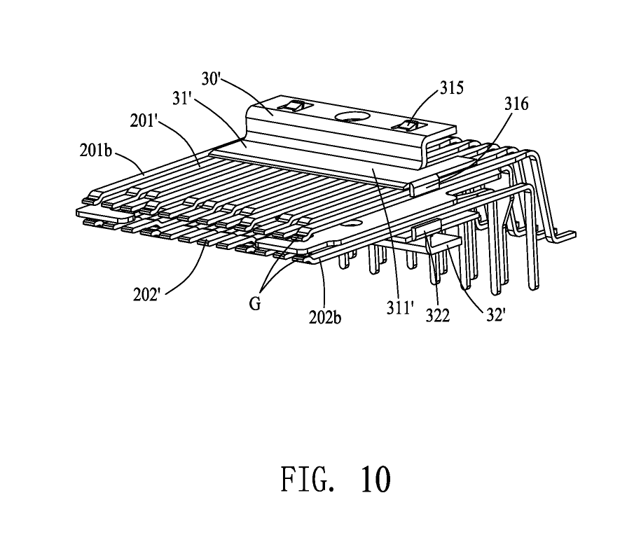

Referring to FIGS. 9 and 10, an electrical connector 1′ according to another embodiment of the present disclosure is disclosed. The major differences between the first embodiment and the second embodiment are the detailed structure of the inner shell 30′ and the way for grounding.

In the second embodiment, the grounding mechanism includes the grounding contacts G located at outmost side of the upper contacts 201′ and the lower contacts 202′. The top shell 31′ includes an upper fixing leg 316 extending downwardly to contact the upper grounding contact G. The bottom shell 32′ includes a lower fixing leg 322 extending upwardly to contact the lower grounding contact G. As a result, the grounding contacts G are in contact with the inner shell 30′.

Comparing with prior arts, the present discloses are provided with the inner shell 30 and the grounding mechanism which can not only help to improve the strength of the tongue portion 102, but also improve shielding effect in contact with the grounding plate 40 and the outer shell. As a result, the signal transmission quality can be greatly improved. Besides, with the top shell 31 and the bottom shell 32 separately made, it is also beneficial to simplify the manufacture.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. An electrical connector comprising:
an insulative housing comprising a base and a tongue portion protruding forwardly from the base, the tongue portion comprising a top surface and a bottom surface opposite to the top surface;
a plurality of contacts retained in the insulative housing, the contacts being divided into a plurality of upper contacts and a plurality of lower contacts, each contact comprising a contacting portion, the contacting portions of the upper contacts and the lower contacts being exposed on the top surface and the bottom surface of the tongue portion, respectively;
a metallic grounding plate positioned between the contacting portions of the upper contacts and the contacting portions of the lower contacts;
a metallic inner shell attached to the insulative housing; wherein
the metallic inner shell and the metallic grounding plate are in contact with each other in order to realize a relative larger grounding area.

2. The electrical connector as claimed in claim 1, wherein the metallic inner shell comprises a top shell and a bottom shell separately made from each other, and wherein the metallic grounding plate is positioned between the top shell and the bottom shell.

3. The electrical connector as claimed in claim 2, wherein the top shell is attached to a top side of the insulative housing, and the bottom shell is attached to a bottom side of the insulative housing.

4. The electrical connector as claimed in claim 2, wherein one of the top shell and the bottom shell comprises a tab, and a remaining one of the top shell and the bottom shell comprises a hole to receive the tab.

5. The electrical connector as claimed in claim 4, wherein the top shell comprises a pair of top sidewalls extending downwardly, the bottom shell comprises a pair of bottom sidewalls extending upwardly, one of the tab and the hole is formed on the top sidewall and a remaining one of the tab and the hole is formed on the bottom sidewall.

6. The electrical connector as claimed in claim 5, wherein the bottom side walls are located outside of the top sidewalls, the tab is stamped from one of the bottom sidewalls and the hole is formed on one of the top sidewalls.

7. The electrical connector as claimed in claim 6, wherein the one of the bottom sidewalls is stamped outwardly to form a pair of rectangular ribs.

8. The electrical connector as claimed in claim 5, wherein the metallic grounding plate defines two slots through which the top sidewalls and the bottom sidewalls extend.

9. The electrical connector as claimed in claim 5, wherein the top sidewalls and the bottom sidewalls are jointed with each other so as to form a rectangular frame.

10. The electrical connector as claimed in claim 1, wherein the metallic grounding plate comprises a pair of soldering legs extending downwardly therefrom for being soldered to a circuit board.

11. The electrical connector as claimed in claim 1, wherein each contacting portion of the upper contacts comprises an upper protrusion bent downwardly from a front end thereof, each contacting portion of the lower contacts comprises a lower protrusion bent upwardly from a front end thereof, the upper protrusions and the lower protrusions are facing each other and are embedded in the tongue portion for fixation.

12. An electrical connector comprising:
an insulative housing comprising a base and a tongue portion protruding forwardly from the base, the tongue portion comprising a top surface and a bottom surface opposite to the top surface;
a plurality of contacts retained in the insulative housing, the contacts being divided into a plurality of upper contacts and a plurality of lower contacts, each contact comprising a contacting portion, the contacting portions of the upper contacts and the lower contacts being exposed on the top surface and the bottom surface of the tongue portion, respectively, the upper contacts comprising an upper grounding contact, the lower contacts comprising a lower grounding contacts in alignment with the upper grounding contact along a vertical direction;
a metallic grounding plate positioned between the contacting portions of the upper contacts and the contacting portions of the lower contacts; and
a metallic inner shell attached to the insulative housing, the metallic inner shell comprising a top shell and a bottom shell separately made from each other; wherein
the top shell comprises an upper fixing leg extending downwardly to contact the upper grounding contact, and the bottom shell comprises a lower fixing leg extending upwardly to contact the lower grounding contact.

13. The electrical connector as claimed in claim 12, wherein the top shell is attached to a top side of the insulative housing, and the bottom shell is attached to a bottom side of the insulative housing.

14. The electrical connector as claimed in claim 12, wherein the metallic grounding plate comprises a pair of soldering legs extending downwardly therefrom for being soldered to a circuit board.

15. The electrical connector as claimed in claim 12, wherein each contacting portion of the upper contacts comprises an upper protrusion bent downwardly from a front end thereof, each contacting portion of the lower contacts comprises a lower protrusion bent upwardly from a front end thereof, the upper protrusions and the lower protrusions are facing each other and are embedded in the tongue portion for fixation.

16. The electrical connector as claimed in claim 12, wherein the insulative housing comprises an upper insulative housing inject-molded with the upper contacts and the top shell, and a lower insulative housing inject-molded with the lower contacts and the bottom shell.

17. The electrical connector as claimed in claim 12, wherein each of the top shell and the bottom shell comprises a pair of elastic tabs.

18. The electrical connector as claimed in claim 12, wherein each upper contact comprises a slant portion extending slantwise from corresponding contacting portion and an upper soldering portion extending from the slant portion, the upper soldering portions being arranged in a single row and coplanar with each other.

19. The electrical connector as claimed in claim 18, wherein each lower contact comprises a lower soldering portion extending downwardly from corresponding contacting portion, the lower soldering portions being arranged in two rows.

20. The electrical connector as claimed in claim 19, wherein the upper soldering portions are located at a rear of the lower soldering portions.
